(19) United States
(12) Patent Application Publication
(10) Pub. No.: US 2023/0020050 A1
(43) Pub. Date: Jan. 19, 2023

(54) SPONGES

(71) Applicant: Edward Mueller, Tomball, TX (US)

(72) Inventor: Edward Mueller, Tomball, TX (US)

(21) Appl. No.: 17/862,994

(22) Filed: Jul. 12, 2022

Related U.S. Application Data
(60) Provisional application No. 63/221,459, filed on Jul. 13, 2021.

(51) Int. Cl. A46B 11/00; A46B 9/00

(52) U.S. Cl. CPC A46B 11/0041; A46B 9/005; A46B 11/0062; A46B 11/0079; A46B 2200/3046; B60S 3/045

(57) ABSTRACT

Various embodiments of sponges are disclosed. A sponge may include a sponge body and a soap container. The sponge may include a soap dispensing member disposed within the sponge body and may include a plurality of apertures to establish fluid communication from inside the soap dispensing member to the sponge body. A first end of the soap dispensing member may be in fluid communication with the soap container. A second end of the soap dispensing member may be closed and terminate inside the sponge body, or it may extend to a second end of the sponge body and be enclosed by a removable plug. The soap container may be removably secured to the sponge body or the soap dispensing member, such as with an annular flange connected to the sponge body. A sponge may include a second soap container, and/or a plurality of nubs projecting the sponge body.

### RELATED APPLICATIONS

This application claims the benefit of U.S. Provisional Application No. 63/221,459, filed Jul. 13, 2021, the contents of which are fully incorporated herein by reference.

### BACKGROUND OF THE INVENTIONS

### 1. Field of the Inventions

The present inventions generally pertain to cleaning products, and more particularly to improved sponges for washing vehicles and any other object or surface in need of cleaning.

### 2. Description Of The Related Art

The use of sponges to clean dirty vehicles is well known. Sponges have traditionally been used by dipping the sponge into a container of soapy water, then pulling the soapy sponge out of the water, and using it to apply soap over a section of a vehicle or surface to be cleaned. It will not take long for the soapy water to be squeezed out of the sponge, at which point the sponge must be dipped back into the container of soapy water and then moved back to wash the next dirty section of the vehicle or surface. This process is repeated numerous times until the entire vehicle or surface has been washed. It has been discovered that it is desireable to have a sponge that is pre-loaded with on-board liquid soap to avoid the need to repeatedly dip the sponge in soapy water. It has also been discovered that it is desireable to also provide sponges with something other than a smooth surface found on traditional sponges to enhance the scrubbing and cleaning capacity of the sponge.

As will become apparent from the description and explanation set forth below, the present inventions address the above-described and other needs by providing various embodiments of improved sponges.

### SUMMARY OF THE INVENTIONS

In one aspect, the present inventions may comprise a sponge having a sponge body and a soap container. The soap container may be secured to one end of the sponge body. The soap container may be largely located outside of the sponge body, or varying degrees or proportions of the soap container may be located outside and inside the sponge body. The sponge body may include an annular base member or similar structure adapted for connecting the soap container to the sponge body. The soap container may be releasably connected to the sponge body. The sponge body may include an internal soap dispensing member, such as a tube, that may be directly or indirectly connected to the soap dispenser and in fluid communication therewith. The internal soap dispensing member preferably includes a plurality of holes therethrough. The soap container may be filled with liquid soap and adapted to communicate the liquid soap into the internal soap dispensing member and through the holes in the internal soap dispensing member into the sponge body. By squeezing or pumping the sponge body, the liquid soap will bubble to the outer surface of the sponge body, which can then be used to apply the soap to a surface to be cleaned. The sponge body may also include a plurality of nubs or protrusions to facilitate the scrubbing and cleaning ability of the sponge.

In one aspect, the present inventions may include a sponge comprising: a sponge body having a first end and a second end, a soap container releasably engageable with the sponge body, and a longitudinal soap dispensing member disposed within the sponge body, a first end of the longitudinal soap dispensing member being connected to and in fluid communication with the soap container, a second end of the longitudinal soap dispensing member being closed, the longitudinal soap dispensing member including a plurality of apertures, an inner chamber of the longitudinal soap dispensing member being in fluid communication with the sponge body through the plurality of apertures in the longitudinal soap dispensing member. Another feature of this aspect of the present inventions may be that the sponge may further include a flange secured to the first end of the sponge body, the soap container being releasably engageable with the flange, and the first end of the longitudinal soap dispensing member being connected to the flange. Another feature of this aspect of the present inventions may be that the flange includes an upstanding cylindrical side wall including internal threads, the sponge further including an annular base member including external threads adapted for threadable engagement with the internal threads on the flange. Another feature of this aspect of the present inventions may be that the annular base member includes a floor including a central passageway adapted for sealing engagement with the first end of the longitudinal soap dispensing member, and the central passageway is adapted to establish fluid communication between the soap container and the longitudinal soap dispensing member. Another feature of this aspect of the present inventions may be that a lower end of the soap container is adapted for removable engagement with the annular base member. Another feature of this aspect of the present inventions may be that the soap container includes an open upper end and the sponge further includes a soap container lid adapted for releasable engagement with the open upper end of the soap container. Another feature of this aspect of the present inventions may be that the sponge may further include a second soap container partially disposed within the second end of the sponge body, a lower end of the second soap container including a nipple extending from the second end of the sponge body. Another feature of this aspect of the present inventions may be that the sponge may further include an annular base member having a downwardly extending annular wall, the annular base member being positioned inside the sponge body, an inner surface of the downwardly extending annular wall including an annular recess adapted for releasable engagement with an annular ridge disposed around an exterior surface of the second soap container. Another feature of this aspect of the present inventions may be that the sponge may further include a plurality of nubs extending upwardly away from an exterior surface of the sponge body.

In another aspect, the present inventions may include a sponge comprising: a sponge body having a first end and a second end, a soap container releasably engageable with a first end of the sponge body, a longitudinal soap dispensing member disposed within the sponge body, a first end of the longitudinal soap dispensing member being connected to and in fluid communication with the soap container, a second end of the longitudinal soap dispensing member extending to the second end of the sponge body and having an open end, the longitudinal soap dispensing member including a plurality of apertures, an inner chamber of the longitudinal soap dispensing member being in fluid communication with the sponge body through the plurality of apertures in the longitudinal soap dispensing member, and an end plug adapted for releasable engagement with the second end of the longitudinal soap dispensing member. Another feature of this aspect of the present inventions may be that the first end of the longitudinal soap dispensing member includes an annular flange, the annular flange being located adjacent the first end of the sponge body, and the soap container being releasably engageable with the annular flange. Another feature of this aspect of the present inventions may be that the soap container includes an open upper end and the sponge further includes a soap container lid adapted for releasable engagement with the open upper end of the soap container. Another feature of this aspect of the present inventions may be that the sponge may further include a plurality of nubs extending upwardly away from an exterior surface of the sponge body.

In another aspect, the present inventions may include a sponge comprising: a sponge body having a first end, a second end, an open bore extending into the first end of the sponge body, a first recessed opening between the open bore and a first side of the sponge body, and a second recessed opening between the open bore and a second side of the sponge body, a soap container positioned in the open bore and adjacent the first and second recessed openings, and a longitudinal soap dispensing member disposed within the sponge body, a first end of the longitudinal soap dispensing member being connected to and in fluid communication with the soap container, a second end of the longitudinal soap dispensing member extending to the second end of the sponge body and having an open end, the longitudinal soap dispensing member including a plurality of apertures, an inner chamber of the longitudinal soap dispensing member being in fluid communication with the sponge body through the plurality of apertures in the longitudinal soap dispensing member. Another feature of this aspect of the present inventions may be that the sponge body includes a first lower surface, a first angled wall and a second angled wall which together define the first recessed opening, and the sponge body includes a second lower surface, a third angled wall and a fourth angled wall which together defined the second recessed opening. Another feature of this aspect of the present inventions may be that the sponge may further include an annular base member disposed adjacent a lower end of the open bore, the soap container being adapted for releasable engagement with the annular base member, and the first end of the longitudinal soap dispensing member being connected to the annular base member. Another feature of this aspect of the present inventions may be that the annular base member includes a floor surface and a downwardly extending stem extending from the floor surface, the downwardly extending stem including a longitudinal central passageway therethrough. Another feature of this aspect of the present inventions may be that the first end of the longitudinal soap dispensing member is adapted for engagement with the downwardly extending stem. Another feature of this aspect of the present inventions may be that the soap container includes an open upper end and the sponge further includes a soap container lid adapted for releasable engagement with the open upper end of the soap container. Another feature of this aspect of the present inventions may be that the sponge may further include a plurality of nubs extending upwardly away from an exterior surface of the sponge body.

Other features, aspects and advantages of the present inventions will become apparent from the following discussion and detailed description.

### BRIEF DESCRIPTION OF THE DRAWINGS

FIG. 1 is a perspective view of an improved sponge constructed in accordance with a specific embodiment of the present inventions, which includes a soap container situated outside of one end of the sponge and in fluid communication with a longitudinal soap dispensing member having a plurality of holes disposed therein through which soap may be communicated to the sponge body.

FIG. 2 is a cross-sectional view taken along line 2-2 of FIG. 1.

FIG. 2A is a partial view similar to FIG. 2 that illustrates an alternative embodiment of an external soap container.

FIG. 2B is an enlarged view of a portion of FIG. 2A that illustrates mating engagement of a removable lid for use on the external soap container.

FIG. 3 is another view similar to FIG. 2 and illustrating another specific embodiment of an improved sponge constructed in accordance with the present inventions, including an internal soap dispensing member that extends to a lower end of the sponge and that may connected to the external soap container on an upper end and having a removable cap on the lower end.

FIG. 4 is another view similar to FIG. 2 and illustrating another specific embodiment of an improved sponge constructed in accordance with the present inventions, including a second soap dispenser disposed within one end of the sponge and having an exit port extending out of the end of the sponge.

FIG. 4A is an enlarged view of a portion of the second soap dispenser.

FIG. 5 is an end view of another specific embodiment of an improved sponge constructed in accordance with the present inventions, in which a soap dispenser is partially disposed within the sponge.

FIG. 6 is a cross-sectional view taken along line 6-6 of FIG. 5.

FIG. 6A is enlarged view of a portion of a connection between the soap container and a dispensing member disposed within the sponge.

FIG. 7 is a side view of a specific embodiment of a soap container connected to a specific embodiment of a soap dispensing member that may be installed in a sponge.

FIG. 7A is an enlarged view a connection between the soap container and the soap dispensing member shown in FIG. 7.

FIG. 8 is another specific embodiment of an improved sponge constructed in accordance with the present inventions, and illustrating a plurality of nubs or projections on one side of the sponge.

While the inventions will be described in connection with the preferred embodiments, it will be understood that the scope of protection is not intended to limit the inventions to those embodiments. On the contrary, the scope of protection is intended to cover all alternatives, modifications, and equivalents as may be included within the spirit and scope of the inventions as defined by the appended claims.

### DETAILED DESCRIPTION OF THE INVENTION

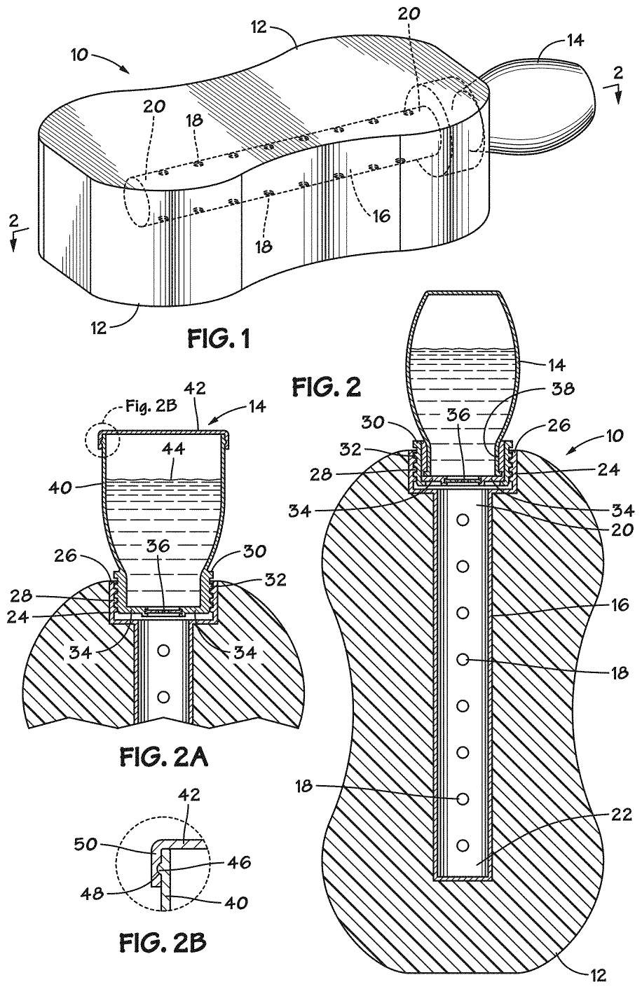

Referring to the drawings in detail, wherein like numerals denote identical elements throughout the several views, and referring initially to FIGS. 1 and 2, there is shown a perspective view of a sponge 10 having a sponge body 12. In a specific embodiment, the sponge 10 may include a soap container 14 in fluid communication with an internal longitudinal soap dispensing member 16. In a specific embodiment, the internal soap dispensing member 16 may be a tubular member having a plurality of holes or apertures 18 disposed through the wall of the tubular member 16. In a specific embodiment, the internal soap dispensing member 16 may include a first end 20 connected to the soap container 14 and a second end 22 that is closed and terminates within the sponge body 12.

As best shown in FIG. 2, the first end 20 of the internal soap dispensing member 16 may include or be attached to an annular flange 24 having an upstanding cylindrical side wall 26 that may include internal threads 28. In a specific embodiment, the sponge 10 may include an annular base member 30 that may include external threads 32 adapted for threadable engagement with the internal threads 28 on the annular flange 24. The annular base member 30 may include a floor 34 having a central passageway 36 adapted for sealing engagement with the first end 20 of the internal soap dispensing member 16. The central passageway 36 is adapted and situated to establish fluid communication between the soap container 14 and the internal soap dispensing member 16.

In a specific embodiment, a lower end 38 of the soap container 14 may be adapted for removable engagement with the annular base member 30. In another specific embodiment, as shown in FIG. 2A, the annular base member 30 may be formed as part of the lower end 38 of the soap container 14. In a specific embodiment, as shown in FIG. 2A, an upper end 40 of the soap container 14 may include a removable cover 42 to allow for refilling the soap container 14 with liquid soap 44. In a specific embodiment, as best shown in FIG. 2B, an exterior surface of the upper end 40 of the soap container 14 may include an annular ridge 46 adapted for releasable engagement with an annular groove 48 disposed in an inner surface of a downwardly extending lip 50 of the removable cover 42.

In a specific embodiment, the soap container 14 may be squeezable pursuant to which squeezing or pumping of the soap container 14 will dispense liquid soap from the soap container 14 through the central passageway 36 into the internal soap dispensing member 16, and into the sponge body 12 and to an outer surface thereof. Then, the sponge 10 may be used to wash a surface in need of cleaning, such as on a vehicle. In use, the sponge 10 is squeezed to dispense liquid soap through the apertures 18 in the internal soap dispensing member 16 and into the sponge body 12, from where it will bubble to the outer surface of the sponge body 12 and then applied to the surface to be cleaned. In this way, the entire exterior surface of a vehicle can be washed with soap without the need to continuously dip the sponge in soapy water.

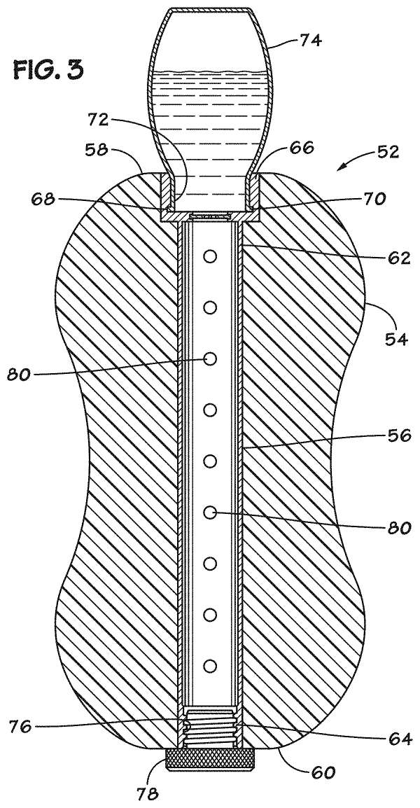

Referring now to FIG. 3, another specific embodiment of a sponge 52 having a sponge body 54 is shown. The sponge 52 shown in FIG. 3 is similar to the sponge 10 shown in FIGS. 1-2. However, one difference is that the sponge 52 includes an internal soap dispensing member 56 that extends substantially the full length of the sponge body 54 from a first end 58 of the sponge body 54 (or from the annular flange 66 discussed below) to a second end 60 of the sponge body 54. A first end 62 of the internal soap dispensing member 56 is situated adjacent the first end 58 of the sponge body 54, and includes an annular flange 66 similar to the annular flange 24 in the embodiments shown in FIGS. 1-2. The annular flange 66 here, however, does not include internal threads, but instead an internal annular groove 68 adapted for engagement with an annular lip 70 on a lower end 72 of a soap container 74. In other words, in this embodiment, instead of securing the soap container 74 of the annular flange 66 with threads, the soap container 74 is releasably secured to the annular flange 66 through releasable engagement of the annular lip 70 on the soap container 74 with the internal groove 68 on the annular flange 66. It is further noted that the embodiment shown in FIG. 3 does not include an annular base member such as annular base member 30 shown in FIGS. 2 and 2A.

In a specific embodiment, a second end 64 of the internal soap dispensing member 56 is disposed adjacent the second end 60 of the sponge body 54. The second end 64 of the internal soap dispensing member 56 is provided with internal threads 76 adapted for threadable engagement with a threaded end plug 78. The threaded end plug 78 may be removed to fill the internal soap dispensing member 56 with liquid soap. The internal soap dispensing member 56 may include a plurality of holes or apertures 80 through which liquid soap may be dispensed into the sponge body 54.

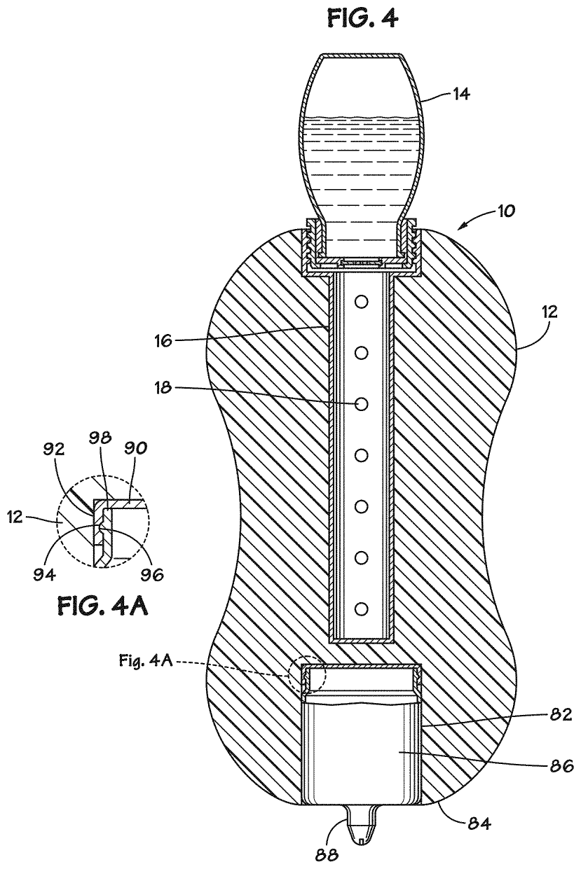

Referring now to FIG. 4, another specific embodiment of a sponge 10 is shown. The embodiment shown in FIG. 4 is similar to the embodiment shown in FIG. 2. The difference is that the sponge 10 shown in FIG. 4 further includes a second soap container 82 partially disposed within the sponge body 12, with a portion of the second soap container 82 exiting the sponge body 12 at a lower end 84 of the sponge body 12. In a specific embodiment, liquid soap 86 contained within the second soap container 82 may be dispensed through a nipple 88 extending from the second soap container 82, such as by squeezing or pumping the second soap container 82.

As shown in FIG. 4A, in a specific embodiment, an annular base member 90 having a downwardly extending annular wall 92 may be secured inside the sponge body 12 and adapted for releasable engagement with the second soap container 82. An inner surface of the downwardly extending annular wall 92 may include an annular recess 94 adapted for engagement with an annular ridge 96 disposed around the second soap container 82 adjacent a distal end 98 of the second soap container 82. The second soap container 82 may be provided to give a user of the sponge 10 a readily available option to spot apply additional liquid soap on an as-needed basis.

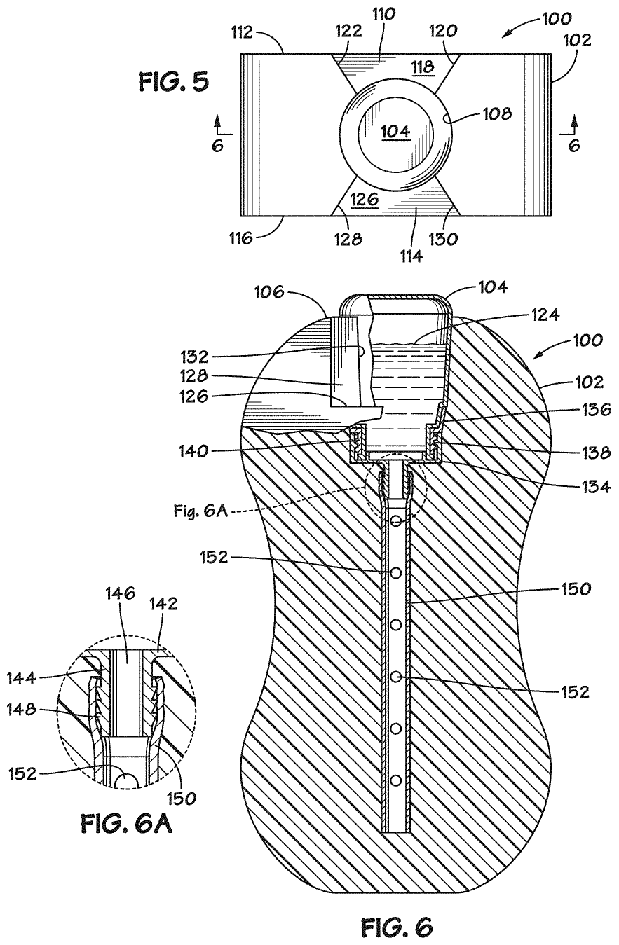

Referring now to FIGS. 5 and 6, another embodiment of a sponge 100 having a sponge body 102 is shown. In a specific embodiment, the sponge 100 may include a soap container 104 that is partially disposed within a first end 106 of the sponge body 102. In a specific embodiment, the first end 106 of the sponge body 102 may include a circular bore 108 extending into the sponge body 102 from the first end 106 of the sponge body 102, and may be sized to receive the soap container 104. The sponge body 102 may include a first recessed opening 110 between the circular bore 108 and a first side 112 of the sponge body 102. The sponge body 102 may include a second recessed opening 114 between the circular bore 108 and a second side 116 of the sponge body 102. The first recessed opening 110 may be defined by a lower surface 118 disposed in generally perpendicular relationship to a first angled wall 120 and a second angled wall 122, which together with the circular bore 108 define a window for viewing a liquid soap level 124 in the soap container 104. The second recessed opening 114 may be defined by a lower surface 126 disposed in generally perpendicular relationship to a third angled wall 128 and a fourth angled wall 130, which together with the circular bore 108 define a window 132 for viewing the liquid soap level 124 in the soap container 104.

With reference to FIG. 6, in a specific embodiment, the sponge 100 may include an annular base member 134 that may be disposed within the sponge body 102. In a specific embodiment, an upper end of an upstanding wall 136 on the annular base member 134 may be disposed adjacent the lower surfaces 118 and 126 of the first and second recessed openings 110 and 114, respectively. In a specific embodiment, an internal surface of the upstanding wall 136 on the annular base member 134 may include threads 138 adapted for engagement with corresponding threads 140 on a lower end of the soap container 104. In this manner, the soap dispenser 104 can be removed and reattached to the sponge body 102 for purposes of re-filling the soap dispenser 104 with liquid soap.

As best shown in FIG. 6A, a floor surface 142 of the annular base member 134 may include a downwardly extending stem 144 having a longitudinal central passageway 146 therethrough. In a specific embodiment, the downwardly extending stem 144 may include an outer surface having a plurality of upwardly angled barbs 148. In a specific embodiment, an upper end of an internal soap dispensing member 150, such as a section of flexible tubing, may be pushed upwardly around the barbs 148 on the stem 144 to secure the soap dispensing member 150 to the stem 144, and thereby establish fluid communication from the soap container 104 through the central passageway 146 in the stem 144 and into the soap dispensing member 150. As with the other embodiments, the soap dispensing member 150 may include a plurality of holes or apertures 152 to allow passage of liquid soap into the sponge body 102.

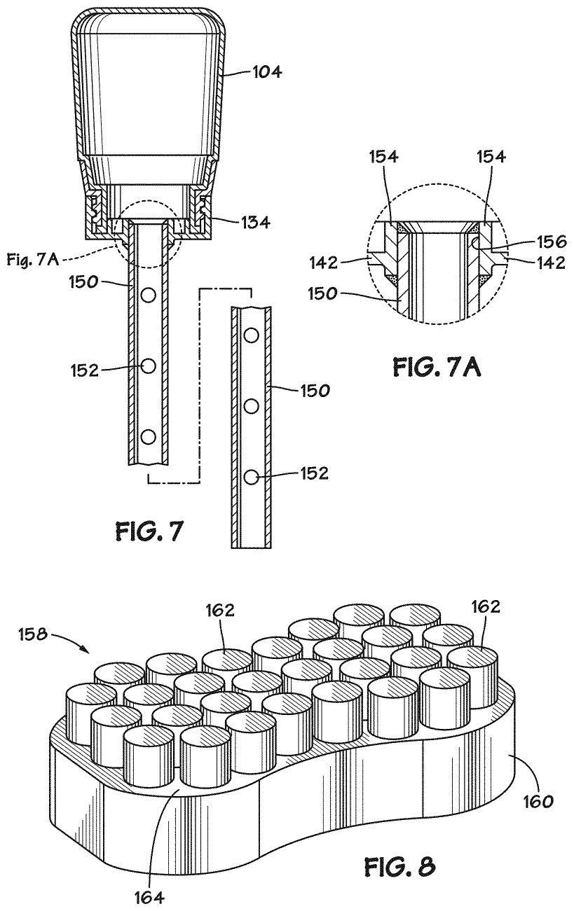

An alternative embodiment of the connection between the soap dispensing member 150 to the soap container 104 as shown in FIGS. 6 and 6A is shown in FIGS. 7 and 7A. As best shown in FIG. 7A, in a specific embodiment, the floor surface 142 of the annular base member 134 may include a central annular wall 154 having a bore 156 therethrough. The bore 156 is adapted to receive and hold the upper end of the soap dispensing member 150.

Referring now to FIG. 8, another specific embodiment of a sponge 158 having a sponge body 160 is shown. In a specific embodiment, the sponge 158 may include a plurality of nubs or protrusions 162 extending upwardly away from the sponge body 160. In a specific embodiment, the nubs 162 may be disposed in generally perpendicular relationship to an upper surface 164 of the sponge body 160. In a specific embodiment, the nubs 162 may be in the general shape of a cylinder. However, the present inventions are not limited to any particular shape for the nubs 162.

It is to be understood that the inventions disclosed herein are not limited to the exact details of construction, operation, exact materials or embodiments shown and described. Although specific embodiments of the inventions have been described, various modifications, alterations, alternative constructions, and equivalents are also encompassed within the scope of the inventions. Although the present inventions may have been described using a particular series of steps, it should be apparent to those skilled in the art that the scope of the present inventions is not limited to the described series of steps. The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims set forth below. Accordingly, the inventions are therefore to be limited only by the scope of the appended claims. None of the claim language should be interpreted pursuant to 35 U.S.C. 112(f) unless the word “means” is recited in any of the claim language, and then only with respect to any recited “means” limitation.

1. A sponge comprising:
a sponge body having a first end and a second end,
a soap container releasably engageable with the sponge body, and
a longitudinal soap dispensing member disposed within the sponge body, a first end of the longitudinal soap dispensing member being connected to and in fluid communication with the soap container, a second end of the longitudinal soap dispensing member being closed, the longitudinal soap dispensing member including a plurality of apertures, an inner chamber of the longitudinal soap dispensing member being in fluid communication with the sponge body through the plurality of apertures in the longitudinal soap dispensing member.

2. The sponge of claim 1, further including a flange secured to the first end of the sponge body, the soap container being releasably engageable with the flange, and the first end of the longitudinal soap dispensing member being connected to the flange.

3. The sponge of claim 2, wherein the flange includes an upstanding cylindrical side wall including internal threads, the sponge further including an annular base member including external threads adapted for threadable engagement with the internal threads on the flange.

4. The sponge of claim 3, wherein the annular base member includes a floor including a central passageway adapted for sealing engagement with the first end of the longitudinal soap dispensing member, and the central passageway is adapted to establish fluid communication between the soap container and the longitudinal soap dispensing member.

5. The sponge of claim 2, wherein a lower end of the soap container is adapted for removable engagement with the annular base member.

6. The sponge of claim 1, wherein the soap container includes an open upper end and the sponge further includes a soap container lid adapted for releasable engagement with the open upper end of the soap container.

7. The sponge of claim 1, further including a second soap container partially disposed within the second end of the sponge body, a lower end of the second soap container including a nipple extending from the second end of the sponge body.

8. The sponge of claim 7, further including an annular base member having a downwardly extending annular wall, the annular base member being positioned inside the sponge body, an inner surface of the downwardly extending annular wall including an annular recess adapted for releasable engagement with an annular ridge disposed around an exterior surface of the second soap container.

9. The sponge of claim 1, further including a plurality of nubs extending upwardly away from an exterior surface of the sponge body.

10. A sponge comprising:
a sponge body having a first end and a second end,
a soap container releasably engageable with a first end of the sponge body,
a longitudinal soap dispensing member disposed within the sponge body, a first end of the longitudinal soap dispensing member being connected to and in fluid communication with the soap container, a second end of the longitudinal soap dispensing member extending to the second end of the sponge body and having an open end, the longitudinal soap dispensing member including a plurality of apertures, an inner chamber of the longitudinal soap dispensing member being in fluid communication with the sponge body through the plurality of apertures in the longitudinal soap dispensing member, and
an end plug adapted for releasable engagement with the second end of the longitudinal soap dispensing member.

11. The sponge of claim 10, wherein the first end of the longitudinal soap dispensing member includes an annular flange, the annular flange being located adjacent the first end of the sponge body, and the soap container being releasably engageable with the annular flange.

12. The sponge of claim 10, wherein the soap container includes an open upper end and the sponge further includes a soap container lid adapted for releasable engagement with the open upper end of the soap container.

13. The sponge of claim 10, further including a plurality of nubs extending upwardly away from an exterior surface of the sponge body.

14. A sponge comprising:
a sponge body having a first end, a second end, an open bore extending into the first end of the sponge body, a first recessed opening between the open bore and a first side of the sponge body, and a second recessed opening between the open bore and a second side of the sponge body,
a soap container positioned in the open bore and adjacent the first and second recessed openings, and
a longitudinal soap dispensing member disposed within the sponge body, a first end of the longitudinal soap dispensing member being connected to and in fluid communication with the soap container, a second end of the longitudinal soap dispensing member extending to the second end of the sponge body and having an open end, the longitudinal soap dispensing member including a plurality of apertures, an inner chamber of the longitudinal soap dispensing member being in fluid communication with the sponge body through the plurality of apertures in the longitudinal soap dispensing member.

15. The sponge of claim 14, wherein the sponge body includes a first lower surface, a first angled wall and a second angled wall which together define the first recessed opening, and the sponge body includes a second lower surface, a third angled wall and a fourth angled wall which together defined the second recessed opening.

16. The sponge of claim 14, further including an annular base member disposed adjacent a lower end of the open bore, the soap container being adapted for releasable engagement with the annular base member, and the first end of the longitudinal soap dispensing member being connected to the annular base member.

17. The sponge of claim 16, wherein the annular base member includes a floor surface and a downwardly extending stem extending from the floor surface, the downwardly extending stem including a longitudinal central passageway therethrough.

18. The sponge of claim 17, wherein the first end of the longitudinal soap dispensing member is adapted for engagement with the downwardly extending stem.

19. The sponge of claim 14, wherein the soap container includes an open upper end and the sponge further includes a soap container lid adapted for releasable engagement with the open upper end of the soap container.

20. The sponge of claim 14, further including a plurality of nubs extending upwardly away from an exterior surface of the sponge body.
